(19) United States
(12) Patent Application Publication
(10) Pub. No.: US 2024/0277058 A1
(43) Pub. Date: Aug. 22, 2024

(54) AEROSOL GENERATING DEVICE

(71) Applicant: Nicoventures Trading Limited, London (GB)

(72) Inventors: Dean COWAN, London (GB); Matthew HODGSON, London (GB); Jeremy CAMPBELL, London (GB); Benjamin TAYLOR, London (GB); Richard HEPWORTH, London (GB)

(21) Appl. No.: 18/568,967

(22) PCT Filed: Jun. 17, 2022
(86) PCT No.: PCT/EP2022/066632

§ 371 Date: Dec. 11, 2023

(30) Foreign Application Priority Data
Jun. 18, 2021 (GB) 2108767.1

(51) Int. Cl. A24F 40/465; A24D 1/20; A24F 40/20; A24F 40/46; H05B 3/04

(52) U.S. Cl. CPC A24F 40/465; A24D 1/20; A24F 40/20; A24F 40/46; H05B 3/04

(57) ABSTRACT

An aerosol generating device (101) is described. The device (101) generates an aerosol from aerosol-generating material. The device (101) has a receptacle (212) defining a heating zone (215) in which at least a portion of an article (110) comprising aerosol-generating material is received. A heating element (220) protrudes into the heating zone (215). A seal (300) is arranged to seal between the article (110) and at least one of the receptacle (212) and the heating element (220).

### RELATED APPLICATIONS

The present application is a National Phase entry of PCT Application No. PCT/EP2022/066632 filed Jun. 17, 2022, which claims priority to GB Application No. 2108767.1 filed Jun. 18, 2021, each of which is hereby incorporated by reference in their entirety.

### TECHNICAL FIELD

The present invention relates to aerosol generating device for generating an aerosol from aerosol-generating material. The present invention also relates to an aerosol provision system comprising an aerosol generating device and an article comprising aerosol-generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect, there is provided an aerosol generating device for generating an aerosol from aerosol-generating material comprising: a receptacle defining a heating zone configured to receive at least a portion of an article comprising aerosol-generating material, a heating element protruding into the heating zone; and a seal configured to seal between the article and at least one of the receptacle and the heating element.

The heating element may be configured to be heated to a temperature sufficient to generate aerosol from the aerosol generating material.

The seal may protrude in the heating zone.

The device may comprise an opening at a proximal end of the receptacle through which at least a portion of an article is received and a distal end; wherein the seal is at the distal end.

The seal may be spaced from the opening.

The seal may extend around the heating element.

The seal may comprise at least one of a lip seal, an o-ring, and a face seal. The seal may comprise at least one of a chamfer, a collar, a shoulder, a gasket, a skirt, and a protrusion.

The seal may comprise a seal member. The seal member may be a circumferentially extending seal member. The seal member may comprise a flexible member. The seal member may comprise a resilient member.

The seal may be a rigid member.

The seal member may be retained by one or both of the receptacle and heating element.

The seal may comprise at least two seal members. The seal may comprise a plurality of ridges.

The seal member may comprise a circumferentially extending protrusion.

At least two seal members may be axially spaced along the heating zone. At least two seal members may be radially spaced.

The seal member may extend circumferentially around the heating element. The seal member may extend circumferentially around the heating zone. The seal may be spaced from the receptacle.

The seal may be configured to seal with the article at a juncture of the heating element and the receptacle.

The heating element may comprise at least a part of the seal.

The heating element may comprise a heating member and a seal member of the seal around the heating member.

The seal member may comprise a chamfer of the heating element. The seal member may comprise a shoulder of the heating element. The seal member may comprise a step of the heating element. The seal member may comprise a collar of the heating element. The collar may be a circumferentially extending protrusion.

The seal member may be integrally formed with the heating member. As used herein, the term ‘integrally formed’ is intended to mean that the features are not separable.

The seal member may form a one-piece component with the heating member. As used herein, the term ‘one-piece component’ is intended to mean that the features are formed together such that no joints are defined therebetween.

The seal member may be formed from the same material as the heating member.

The seal member may be formed from a different material from the heating member. The seal member may be molded with the heating member. The seal member may be bonded to the heating member.

The heating element may comprise heating material that is heatable by penetration with a varying magnetic field.

The seal may comprise heating material that is heatable by penetration with a varying magnetic field.

The seal may be free of heating material that is heatable by penetration with a varying magnetic field.

The receptacle may comprise at least a part of the seal.

The receptacle may comprise a base and a peripheral wall.

The peripheral wall may comprise an elongate hollow member. The seal may protrude from the elongate hollow member. The seal may protrude inwardly. The elongate hollow member may be tubular. The base may close one end of the elongate hollow member.

The base may comprise a seal member of the seal. The seal member may upstand from the base.

The peripheral wall may comprise a seal member of the seal.

The seal may protrude into the heating zone from the receptacle.

The seal member may be integrally formed with the receptacle. The seal member may form a one-piece component with the receptacle. The seal member may be formed from the same material as the receptacle. The seal member may be formed from a different material from the receptacle. The seal member may be molded with the receptacle. The seal member may be bonded to the receptacle.

The receptacle may be free from heating material that is heatable by penetration with a varying magnetic field.

The seal may be spaced from the base.

The seal may be configured to seal with an end of the article.

The seal may be configured to seal between the heating element and the article.

The seal may be configured to seal with an inner side of a bore of the article. The seal may be configured to seal between the receptacle and an outer side of the article.

The seal may be configured to isolate an air path defined between the article and at least one of the receptacle and the heating element. The seal may be configured to define an air path through the article which is isolated from at least part of a gap formed between the receptacle and the article.

The heating element may comprise an air outlet to the heating zone and an airpath defined in the heating element.

The seal may be arranged to at least one of deform and distend at least a portion of an article when the article is received in the heating zone.

The seal may be arranged to at least one of distend and deform when at least a portion of an article is received in the heating zone.

The heating element may comprise a portion extending external from the receptacle. The heating element may comprise a first portion external to the heating zone and a second portion protruding in the heating zone. The portion extending external from the receptacle may be heated and be thermally conductively connected with the portion of the heating element in the heating zone. As used herein, the term ‘conductively connected between’ does not necessarily mean that two features are directly connected between, and such an arrangement may include one or further features therebetween.

The device may comprise a magnetic field generator including an inductor coil configured to generate a varying magnetic field.

The inductor coil may be a helical inductor coil. The inductor coil may be at least one of a planar coil and a spiral coil. The spiral coil may be a flat spiral coil.

The heating element may comprise part of a resistive heating arrangement.

The apparatus of this aspect can include one or more, or all, of the features described below, as appropriate.

According to an aspect, there is provided an aerosol provision system comprising an aerosol generating device as described above, and an article comprising aerosol-generating material.

According to an aspect, there is provided an aerosol-generating system comprising an article comprising aerosol-generating material; and an aerosol generating device for heating aerosol-generating material comprising: a receptacle defining a heating zone configured to receive at least a portion of the article; a heating element that protrudes into the heating zone; and a seal on at least one of the receptacle and the heating element configured to define at least part of an air path extending through the article which is isolated from at least part of a gap formed between the receptacle and the article.

The article may comprise a pre-formed bore configured to receive the heating element.

The seal may be configured to seal with a face of the bore.

The article may comprise an engaging feature configured to engage with the seal.

The engaging feature may be at least one of a bore, a collar, a shoulder, a ridge, a protrusion, a recess, a lip, a chamfer, a region of increased thickness, a region of reduced thickness, a face and an edge.

The seal may be configured to engage with a relatively more resilient engaging feature of the article.

The seal may be configured to engage with a relatively less resilient engaging feature of the article.

The article may comprise an outer side of the article, and the seal may be configured to at least one of deform and distend an outer side of the article when the article is received in the heating zone.

The seal may be configured to compress the article.

The seal may be configured to form an indent in the outer side of the article

The article may comprise an outer side, and the seal may be configured to at least one of deform and distend the outer side of the article when the article is received in the heating zone. Insertion of the article may be configured to deform the seal.

The article may be a consumable.

The heating element may be removable from the heating zone. The heating element may be interchangeable.

The heating element may upstand from the base. The heating element may comprise a sharp edge or point at a free end. The heating element may be a pin or blade. The heating element may be configured to pierce the article received by the heating zone.

The heating element and receptacle may be co-axial.

The apparatus of this aspect can include one or more, or all, of the features described above, as appropriate.

The aerosol generating device may be a non-combustible aerosol generating device.

The device may be a tobacco heating device, also known as a heat-not-burn device.

The aerosol generating material may be non-liquid aerosol generating material.

The article may be dimensioned to be at least partially received within the heating zone.

According to an aspect, there is provided an aerosol generating device for generating an aerosol from aerosol-generating material comprising: a receptacle defining a heating zone configured to receive at least a portion of an article comprising aerosol-generating material, and a heating element arranged to heat the heating zone.

According to an aspect, there is provided an aerosol-generating system comprising an article comprising aerosol-generating material; an aerosol generating device for heating aerosol-generating material comprising a heating zone configured to receive at least a portion of the article; and a heating element.

According to an aspect, there is provided an aerosol generating device for generating an aerosol from aerosol-generating material comprising: a heating element configured to be received within at least a portion of an article comprising aerosol-generating material; a base from which the heating element protrudes; and a seal arranged to seal between the article and at least one of the base and the heating element.

The heating element may be configured to be heated to a temperature sufficient to generate aerosol from the aerosol generating material.

The device may comprise a heating zone around the heating element and may be configured to at least partially receive the article comprising aerosol-generating material.

The seal may protrude in the heating zone.

The device may comprise a housing, wherein the housing defines the base.

At least part of the heating element may be exposed.

The seal may extend around the heating element.

The seal may extend around the base end of the heating element.

The seal may comprise at least one of a lip seal, an o-ring, and a face seal.

The seal may comprise at least one of a chamfer, a collar, a shoulder, a gasket, and a protrusion.

The seal may comprise a seal member. The seal member may be a circumferentially extending seal member. The seal member may comprise a flexible member. The seal member may comprise a resilient member.

The seal may be a rigid member.

The seal member may be retained by one or both of the housing and heating element.

The seal may comprise at least two seal members. The seal may comprise a plurality of ridges.

The seal member may comprise a circumferentially extending protrusion.

At least two seal members may be axially spaced along the heating zone. At least two seal members may be radially spaced.

The seal member may extend circumferentially around the heating element.

The seal may be configured to seal with the article at a juncture of the heating element and the base.

The base may comprise at least a part of the seal.

The heating element may comprise a heating member and a seal member of the seal around the heating member.

The seal member may comprise a chamfer of the heating element. The seal member may comprise a shoulder of the heating element. The seal member may comprise a step of the heating element. The seal member may comprise a collar of the heating element. The collar may be a circumferentially extending protrusion.

The seal member may be integrally formed with the heating member. As used herein, the term ‘integrally formed’ is intended to mean that the features are not separable.

The seal member may form a one-piece component with the heating member. As used herein, the term ‘one-piece component’ is intended to mean that the features are formed together such that no joints are defined therebetween.

The seal member may be formed from the same material as the heating member.

The seal member may be formed from a different material from the heating member. The seal member may be molded with the heating member. The seal member may be bonded to the heating member.

The heating element may comprise heating material that is heatable by penetration with a varying magnetic field.

The seal may comprise heating material that is heatable by penetration with a varying magnetic field.

The seal may be free of heating material that is heatable by penetration with a varying magnetic field.

The housing may comprise at least part of the seal. The base may comprise at least part of the seal.

The housing may comprise a seal member of the seal. The base may comprise a seal member of the seal.

The seal member may upstand from the base.

The base may comprise a upstanding rim extending around and spaced from the base end of the heating element.

The seal member may comprise a peripheral protrusion extending from the upstanding rim.

The seal member may protrude from the upstanding rim.

A chamfer may define a tapered portion of the upstanding rim.

The upstanding rim and the base may form a recess.

The recess may house at least part of the heating member.

The seal may be provided in the recess.

The seal member may be integrally formed with the base. The seal member may form a one-piece component with the base. The seal member may be formed from the same material as the base. The seal member may be formed from a different material from the base. The seal member may be molded with the base. The seal member may be bonded to the base.

The seal member may be integrally formed with the upstanding rim. The seal member may form a one-piece component with the upstanding rim. The seal member may be formed from the same material as the upstanding rim. The seal member may be formed from a different material from the upstanding rim. The seal member may be molded with the upstanding rim. The seal member may be bonded to the upstanding rim.

The seal may be spaced from the base.

The seal may be spaced from the upstanding rim.

The seal may be configured to seal with an end of the article.

The seal may be configured to seal between the heating element and the article. The seal may be configured to seal with an inner side of a bore of the article. The seal may be configured to seal between the recess and an outer side of the article. The seal may be configured to seal between the upstanding rim and an outer side of the article.

The seal may be configured to isolate an air path defined between the article and at least one of the base and the heating element.

The heating element may comprise an air outlet to the heating zone and an airpath defined in the heating element.

The heating element may comprise at least a part of the seal.

The heating element may comprise a heating member and a seal member of the seal around the heating member.

The heating element may comprise heating material that is heatable by penetration with a varying magnetic field.

The seal may comprise heating material that is heatable by penetration with a varying magnetic field.

The heating element may comprise an air outlet to the heating zone and an airpath defined in the heating element

The seal may be configured to at least one of deform and distend at least a portion of an article when the heating element is received in at least a portion of the article.

The device may comprise a magnetic field generator including an inductor coil configured to generate a varying magnetic field.

The inductor coil may be a helical inductor coil. The inductor coil may be at least one of a planar coil and a spiral coil. The spiral coil may be a flat spiral coil.

The heating element may comprise part of a resistive heating arrangement

According to an aspect, there is provided, an aerosol-generating system comprising: an article comprising aerosol-generating material; and an aerosol generating device for heating aerosol-generating material comprising: a heating element configured to be received within at least a portion of an article comprising aerosol-generating material; a base from which the heating element protrudes; and a seal on at least one of the base of the housing and the heating element configured to define at least part of an air path extending through the article.

According to an aspect, there is provided an aerosol generating device for generating an aerosol from aerosol-generating material, the device comprising:
a housing;
an exposed heating arrangement protruding from the housing configured to be received within an aerosol-generating article and heat the aerosol-generating article.

The heating arrangement may comprise a heating element protruding from the housing configured to be received within an aerosol-generating article.

The housing may comprise a base from which the heating element protrudes.

A seal may be arranged to seal between the article and at least one of the base and the heating element.

A heating zone may extend around the exposed heating arrangement and be configured to at least partially receive the article comprising aerosol-generating material.

According to an aspect, there is provided, an aerosol-generating system comprising: an article comprising aerosol-generating material; and an aerosol generating device for heating aerosol-generating material according to the above.

The apparatus of these aspects can include one or more, or all, of the features described above, as appropriate.

### BRIEF DESCRIPTION OF THE DRAWINGS

Embodiments will now be described, by way of example only, and with reference to the accompanying drawings in which:

FIG. 1 shows a front perspective view of an aerosol generating system with an aerosol generating device and an article inserted into the device;

FIG. 2 shows schematically the aerosol generating system of FIG. 1;

FIG. 2A shows schematically an aerosol generating system with an aerosol generating device and an article for use with the device;

FIG. 3 shows schematically part of the aerosol generating system of FIG. 1 with the article partially withdrawn from the device;

FIG. 4 shows schematically part of another arrangement of the aerosol generating system of FIG. 1 with the article partially withdrawn from the device;

FIG. 5 shows schematically part of another arrangement of the aerosol generating system of FIG. 1 with the article partially withdrawn from the device;

FIG. 6 shows schematically part of another arrangement of the aerosol generating system of FIG. 1 with the article partially withdrawn from the device;

FIGS. 7a-7e show schematically different heating elements of the aerosol generating device of FIG. 1;

FIGS. 8a-8g show schematically part of different arrangements of the aerosol generating device of FIG. 1;

FIGS. 9a-9c show schematically part of different arrangements of the aerosol generating device of FIG. 2A; and

FIGS. 9e-9g show schematically part of different arrangements of the aerosol generating device of FIG. 2A.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol generating material may include any plant-based material, such as tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

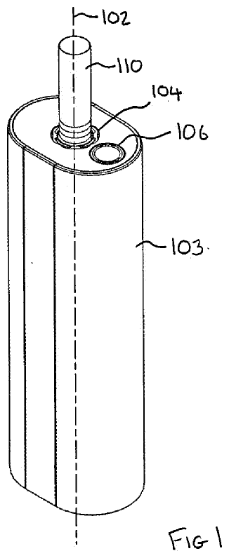

FIG. 1 shows an example of an aerosol generating system 100. The system 100 comprises an aerosol generating device 101 for generating aerosol from an aerosol generating medium/material, and a replaceable article 110 comprising the aerosol generating medium. The device 101 can be used to heat the replaceable article 110 comprising the aerosol generating medium, to generate an aerosol or other inhalable medium which can be inhaled by a user of the device 101.

The device 101 comprises a housing 103 which surrounds and houses various components of the device 101. The housing 103 is elongate. The device 101 has an opening 104 in one end, through which the article 110 can be inserted for heating by the device 101. The article 110 may be fully or partially inserted into the device 101 for heating by the device 101.

In various embodiments, the device 101 is free from an opening. In such an arrangement, the device 101, or a component of, may be partially received within at least a portion of the article 110.

The device 101 may comprise a user-operable control element 106, such as a button or switch, which operates the device 101 when operated, e.g. pressed. For example, a user may activate the device 101 by pressing the switch 106.

The device 101 defines a longitudinal axis 102, along which an article 110 may extend when inserted into the device 101. The opening 104 is aligned on the longitudinal axis 102.

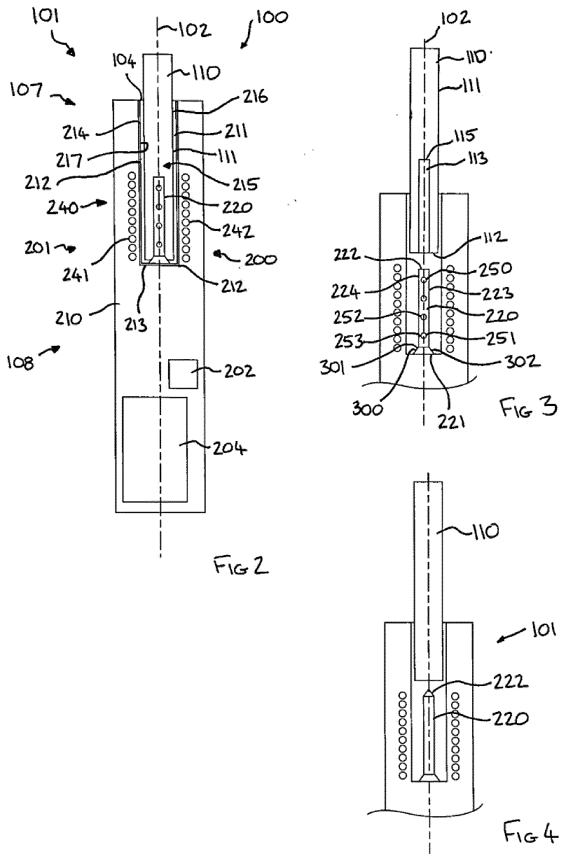

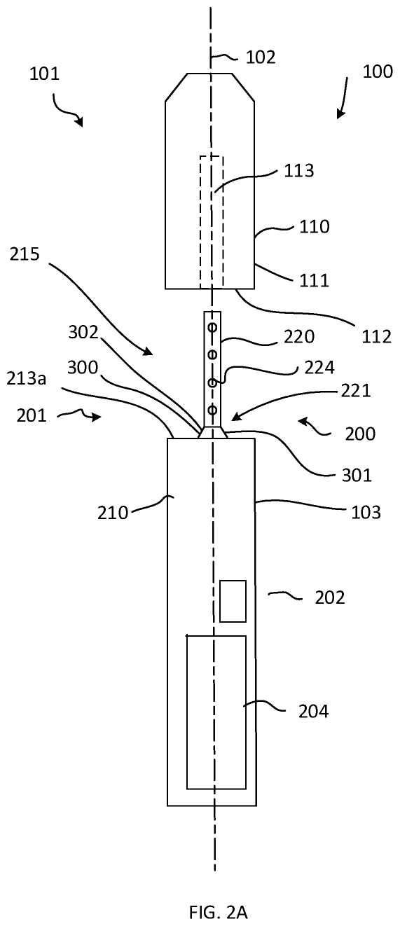

FIG. 2 is a schematic illustration of the aerosol generating system 100 of FIG. 1, showing various components of the device 101. It will be appreciated that the device 101 may include other components not shown in FIG. 2.

As shown in FIG. 2, the device 101 includes an apparatus for heating aerosol-generating material 200. The apparatus 200 includes a heating assembly 201, a controller (control circuit) 202, and a power source 204. The apparatus 200 comprises a body assembly 210. The body assembly 210 may include a chassis and other components forming part of the device. The heating assembly 201 is configured to heat the aerosol-generating medium or material of an article 110 inserted into the device 101, such that an aerosol is generated from the aerosol generating medium. The power source 204 supplies electrical power to the heating assembly 201, and the heating assembly 201 converts the supplied electrical energy into heat energy for heating the aerosol-generating material.

The power source 204 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The power source 204 may be electrically coupled to the heating assembly 201 to supply electrical power when required and under control of the controller 202 to heat the aerosol generating material. The control circuit 202 may be configured to activate and deactivate the heating assembly 201 based on a user operating the control element 106. For example, the controller 202 may activate the heating assembly 201 in response to a user operating the switch 106.

The end of the device 101 closest to the opening 104 may be known as the proximal end (or mouth end) 107 of the device 101 because, in use, it is closest to the mouth of the user. In use, a user inserts an article 110 into the opening 104, operates the user control 106 to begin heating the aerosol generating material and draws on the aerosol generated in the device. This causes the aerosol to flow through the article 110 along a flow path towards the proximal end of the device 101.

The other end of the device furthest away from the opening 104 may be known as the distal end 108 of the device 101 because, in use, it is the end furthest away from the mouth of the user. As a user draws on the aerosol generated in the device, the aerosol flows in a direction towards the proximal end of the device 101. The terms proximal and distal as applied to features of the device 101 will be described by reference to the relative positioning of such features with respect to each other in a proximal-distal direction along the axis 102.

The heating assembly 201 may comprise various components to heat the aerosol generating material of the article 110 via an inductive heating process. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

The apparatus 200 includes a heating chamber 211 configured and dimensioned to receive the article 110 to be heated. The heating chamber 211 defines a heating zone 215. In the present example, the article 110 is generally cylindrical, and the heating chamber 211 is correspondingly generally cylindrical in shape. However, other shapes would be possible. The heating chamber 211 is formed by a receptacle 212. The receptacle 212 includes an end wall 213 and a peripheral wall 214. The end wall 213 acts as a base of the receptacle 212. The receptacle 212 in embodiments is a one-piece component. In other embodiments the receptacle 212 comprises two or more components.

The heating chamber 211 is defined by the inner surfaces of the receptacle 212. The receptacle 212 acts as a support member. The receptacle 212 comprises a generally tubular member. The receptacle 212 extends along and around and substantially coaxial with the longitudinal axis 102 of the device 101. However, other shapes would be possible. The receptacle 212 (and so heating zone 215) is open at its proximal end such that an article 110 inserted into the opening 104 of the device 101 can be received by the heating chamber 211 therethrough. The receptacle 212 is closed at its distal end by the end wall 213. The receptacle 212 may comprise one or more conduits that form part of an air path. In use, the distal end of the article 110 may be positioned in proximity or engagement with the end of the heating chamber 211. Air may pass through the one or more conduits forming part of the air path, into the heating chamber 211, and flow through the article 110 towards the proximal end of the device 101.

The receptacle 212 is formed free of material that is heatable by penetration with a varying magnetic field. The receptacle 212 may be formed from an insulating material. For example, the receptacle 212 may be formed from a plastic, such as polyether ether ketone (PEEK). Other suitable materials are possible. The receptacle 212 may be formed from such materials ensure that the assembly remains rigid/solid when the heating assembly 201 is operated. Using a non-metallic material for the receptacle 212 may assist with restricting heating of other components of the device 101. The receptacle 212 may be formed from a rigid material to aid support of other components.

Other arrangements for the receptacle 212 would be possible. For example, in an embodiment the end wall 213 is defined by part of the heating assembly 201. In embodiments, the receptacle 212 comprises material that is heatable by penetration with a varying magnetic field. As illustrated in FIG. 2, the heating assembly 201 comprises a heating element 220. The heating element 220 is configured to heat the heating zone 215. The heating zone 215 is defined in the heating chamber 211. In embodiments the heating chamber 211 defines a portion of the heating zone 215 or the extent of the heating zone 215.

The heating zone 215 is a zone or volume into which an article may be received for heating by the device 101. The heating zone 215 is defined therefore at least in part by the heating assembly 201. The heating zone 215 is a space adjacent to the heating element 220. In embodiments comprising the heating chamber 211, such as shown in FIG. 2, the heating chamber 211 delimits the heating zone 215. That is, the heating chamber defines the heating zone 215. In embodiments, the heating element 220 defines the heating zone.

As illustrated in FIG. 2A, in various embodiments the apparatus 200 is free from a heating chamber. The heating element protrudes from the housing 103. In such embodiments, the receptacle and heating chamber may be omitted, and the heating element may be surrounded by free space. The heating element, or at least part of the heating element, is free from being surrounded by a peripheral member, such as a peripheral wall of the device when the article is on the heating element. The term ‘heating zone’ will be understood to include a space surrounding the heating element. That is, the heating zone may not be delimited or surrounded by a component of the device 101.

The heating element 220 is heatable to heat the heating zone 215. The heating element 220 is an induction heating element. That is, the heating element 220 comprises a susceptor that is heatable by penetration with a varying magnetic field. The susceptor comprises electrically conducting material suitable for heating by electromagnetic induction. For example, the susceptor may be formed from a carbon steel. It will be understood that other suitable materials may be used, for example a ferromagnetic material such as iron, nickel or cobalt.

The heating assembly 201 comprises a magnetic field generator 240. The magnetic field generator 240 is configured to generate one or more varying magnetic fields that penetrate the susceptor so as to cause heating in the susceptor. The magnetic field generator 240 includes an inductor coil arrangement 241. The inductor coil arrangement 241 comprises an inductor coil 242, acting as an inductor element. The inductor coil 242 is a helical coil, however other arrangements are envisaged. In embodiments, the inductor coil arrangement 241 comprises two or more inductor coils 242. The two or more inductor coils in embodiments are disposed adjacent to each other and may be aligned co-axially along the axis.

In some examples, in use, the inductor coil is configured to heat the heating element 220 to a temperature of between about 200° C. and about 350° C., such as between about 240° C. and about 300° C., or between about 250° ° C. and about 280° C.

In embodiments, the heating element forms part of a heating arrangement. The heating arrangement comprises the heating element protruding from the base. In other embodiments, the heating element is in the article, and the heating arrangement comprises a protruding member protruding from the base. The heating element or protruding member in embodiments comprises the magnetic field generator configured to generate a varying magnetic field including an inductor coil. The heating arrangement in embodiments is an inductive heating arrangement. The heating arrangement in embodiments is a resistive heating arrangement.

The heating element 220 extends in the heating zone 215. The heating element 220, acting as a protruding element, protrudes in the heating zone 215. The heating element 220 upstands from the base.

In embodiments, the base is formed by a feature other than the end wall 213 of the receptacle.

The heating element 220 is spaced from the peripheral wall 214. The heating assembly 201 is configured such that when an article 110 is received by the heating chamber 211, the heating portion 221 of the heating element 220 extends into a distal end of the article 110. The heating element 220 is positioned, in use, within the article 110. The heating element 220 is configured to heat aerosol generating material of an article 110 from within, and for this reason is referred to as an inner heating element.

The heating element 220 extends into the heating chamber 211 from the distal end of the heating chamber 211 along the longitudinal axis 102 of the device (in the axial direction). In embodiments the heating element 220 extends into the heating chamber 211 spaced from the axis 102. The heating element 220 may be off-axis or non-parallel to the axis 102. Although one heating element 220 is shown, it will be understood that in embodiments, the heating assembly 201 comprises a plurality of heating elements 220. Such heating elements in embodiments are spaced from but parallel to each other.

The inductor coil 241 is disposed external to the receptacle 212. The inductor coil 241 encircles the heating zone 215. The helical inductor coil 241 extends around at least a portion of the heating element 220, acting as a susceptor. The helical inductor coil 241 is configured to generate a varying magnetic field that penetrates the heating element 220. The helical inductor coil 241 is arranged coaxially with the heating chamber 211 and longitudinal axis 101.

The inductor coil 241 is a helical coil comprising electrically-conductive material, such as copper. The coil is formed from wire, such as Litz wire, which is wound helically around a support member. The support member is formed by the receptacle 212 or by another component. In embodiments, the support member is omitted. The support member is tubular. The coil 241 defines a generally tubular shape. The inductor coil 241 has a generally circular profile. In other embodiments, the inductor coil 241 may have a different shape, such as generally square, rectangular or elliptical. The coil width may increase or decrease along its length.

Other types of inductor coil may be used, for example a flat spiral coil. With a helical coil it is possible to define an elongate inductor zone in which to receive a susceptor, which provides an elongate length of susceptor to be received in the elongate inductor zone. The length of susceptor subjected to varying magnetic field may be maximised. By providing an enclosed inductor zone with a helical coil arrangement it is possible to aid the flux concentration of the magnetic field.

Litz wire comprises a plurality of individual wires which are individually insulated and are twisted together to form a single wire. Litz wires are designed to reduce the skin effect losses in a conductor. Other wire types could be used, such as solid. The configuration of the helical inductor coil may vary along its axial length. For example, the inductor coil, or each inductor coil, may have substantially the same or different values of inductance, axial lengths, radii, pitches, numbers of turns, etc.

The heating element 220 protrudes in the heating zone 215 and is received by the article 110. FIG. 2 shows the article 110 received in the device 101. The article 110 is sized to be received by the receptacle 212. The outer dimensions of the article 110 perpendicular to the longitudinal axis of the article 110 substantially correspond with the inner dimensions of the chamber 211 perpendicular to the longitudinal axis 102 of the device 101 to allow insertion of the article 110 into the receptacle 212. In embodiments, a gap 216 is defined between an outer side 111 of the article 110 and an inner side 217 of the receptacle 212. The gap 216 may act as an air passage along at least part of the axial length of the chamber 211. An insertion end 112 of the article 110 is arranged to lie adjacent to the base of the receptacle 212.

FIG. 3 shows the article 110 partially inserted into the device 101. As shown, the article 110 is spaced from the heating element 220 in the heating zone 215. The article 110 may be in the process of being inserted or withdrawn from the heating element 215.

The heating element 220 extends in the heating zone 215 from the distal end of the receptacle 212. The heating element 220 upstands from the end wall 213. The heating element 220 comprises a heating member 224. The heating member 224 is elongate. The heating element 220 comprises a base end 221 and an opposing free end 222. The heating portion 221 is a pin or column. Other shapes are envisaged, for example the heating portion 221 in embodiments is a blade.

The heating element 220 comprises an outer surface 223. The outer surface 223 extends around the heating element 220. The outer surface 223 extends between the base end 221 and the free end 222. The outer surface 223 defines an outer side of the heating element 220. The heating element 220 is generally cylindrical although other shapes are envisaged.

An air flow arrangement 250 is provided. The air flow arrangement 250 forms part of an air path through the heating zone 215. The air flow arrangement 250 comprises one or more conduits forming part of the air path along which air may pass into the heating chamber 211. The air flows through the article in the heating chamber 211 towards the proximal end of the device 101. The air flow arrangement 250 comprises an air conduit 251 in the heating element 220. The air conduit 251 communicates external to the receptacle 212 with the heating chamber 211. An air outlet 252 is formed in the heating element 220. The air outlet 252 comprises an array of apertures 253 in the outer surface 223 of the heating element 220. The heating element 220 is tubular with the array of apertures 253 communicating between an inner side and an outer side of the heating element 220. The configuration and arrangement of the air flow arrangement 250, for example the array of aperture, may differ in embodiments. Although four apertures 253 are shown, the array of apertures 253 in embodiments is one or more apertures.

In embodiments, the air flow arrangement 250 differs. The air flow arrangement 250 in embodiments is not formed in the heating element 220. In embodiments, the one or more conduits of the air flow arrangement 250 are formed in the end wall 213 of the receptacle.

The article 110 comprises a bore 113. The bore 113 is pre-formed in the article 110. The bore 113 is formed in embodiments by a tubular portion of the article 110. The bore 113 in embodiments extends partially along the longitudinal axis of the article. The bore 113 comprises an inner surface 114. The bore 113 has a closed end 115. The heating member 224 is sized to be received in the bore 113. The heating member 224 and bore 113 are complimentary sized to form a slide fit. The inner surface 114 of the bore is configured to form a close contact with the heating member 224 to maximise heat transfer between the heating element 220 and the article 110.

The free end 222 in the present embodiment is blunt. Referring to FIG. 4, in embodiments, the bore 113 in the article 110 is omitted. In embodiments the outer dimensions of the heating element are greater than those of the bore. In such arrangements, the heating element is configured to deform and/or distend the article 110 to be inserted into the article 110. To facilitate this, the inner heating element 220 is configured to pierce an article 110 that is inserted into the device 101. In such an embodiment, the free end 222 of the heating element 220 comprises a sharp edge or point. The free end 222 of the heating element 220 in embodiments comprises a sharp edge, point or other guide feature to aid location of the heating element 220 in the article 110.

As shown in FIGS. 2 and 3, the device 101 comprises a seal 300 configured to seal with the article 110 in the heating chamber 211. The seal 300 seals with the article 110 at the base end 221 of the heating element 220. The seal 300 seals the heating element 220 with the insertion end 112 of the article. That is, a sealing action is formed between the article 110 and the heating element 220 at the distal end upon receipt of the article 110 at the distal end.

The seal 300 encircles the heating member 224. The seal 300 comprises a chamfer 301. The chamfer 301 acts as a seal member 305. The chamfer 301 forms a tapered end of the heating element 220. The chamfer 301 comprises a contact surface 302. The contact surface 302 extends at an inclined angle to the longitudinal axis.

In the present embodiment, the chamfer 301 is formed by the heating element 220. In embodiments the chamfer 301 is formed by the base 213 of the receptacle 212. In such an embodiment the chamfer 301 forms a collar mounted around the heating element 220. In another embodiment, the seal 301 is a discrete element on the heating element 220. The discrete seal 301 may be fixedly mounted, for example by moulding or bonding to the heating element 220.

The chamfer 301 of the heating element 220 is integrally formed with the heating member 224. In an embodiment, the chamfer 301 is a one-piece component with the heating member 224. In such an arrangement, the chamfer 301, acting as the seal member, is formed from material that is heatable by penetration with a varying magnetic field. Accordingly the chamfer is heatable.

In embodiments, part of the heating element 220 is formed from material that is not heatable by penetration with a varying magnetic field such that the seal is free of heating material that is heatable by penetration with a varying magnetic field. Similarly, where the chamfer 301 is formed by the base 213 of the receptacle 212 or is a discrete member, the seal may be free of heating material that is heatable by penetration with a varying magnetic field

The seal 300 extends circumferentially around the heating member 224 to form a circumferential seal.

The chamfer 301 is rigid. The chamfer 301, acting as a seal member 305, is arranged to at least one of deform and distend the insertion end 112 of the article when the article 110 is received in the heating zone 215 and urged into contact with the chamfer 301. In other embodiments, the seal member 305 is flexible and/or resilient, as will be described below.

The seal member may be formed from an insulating material. For example, the seal member may be formed from a plastic, such as polyether ether ketone (PEEK). Other suitable materials are possible. The seal member may be formed from such materials ensure that the seal member remains rigid/solid when the heating assembly 201 is operated.

Upon insertion of the article 110, the insertion end 112 is slid over the free end 222 of the heating element 220 so that the heating member 224 is received in the bore 113. Upon contact of the article 110 with the chamfer 301, a rim of the article 110 at the end of the article 110 around the heating member 224 contacts the chamfer 301. The chamfer 301 applies a radial force on the part of the article 110 in contact with the chamfer 301 as the article 110 is urged in an axial direction into the chamber 211. By the seal member 305 acting on the end of the article 110, the seal member 305 causes a sealing action to minimise any gap between the rim of the article formed around the heating member 224 and the heating element 220. With such an arrangement airflow past the rim is minimised. The rim defines an inner rim. A sealing action is therefore created between the article 110 and heating element. Distinct air paths may be defined within the article 110, for example from the apertures 253 in the heating element 220, and external to the article 110, for example, between the outer side 111 of the article 110 and the receptacle 212.

The seal 300 advantageously restricts the flow of air in the heating chamber 211. Accordingly, it is possible to aid with more efficiently supplying air to the article 110 received in the device 101. By providing a barrier in the heating chamber 211, it is possible to define differing air paths within the chamber and so minimise air flow disruption.

The seal 300 in embodiments has different configurations. In the embodiments shown in FIGS. 2 to 4, the seal 300 comprises the chamfer 301. The chamfer 301 is at the juncture of the receptacle and the heating element 220. In embodiments, the seal 300 is spaced from the receptacle 212. In one such embodiment, a gap is defined between the chamfer 301 and the base 213 of the receptacle 212.

In embodiments described with reference to FIGS. 5, 6 and 7a-7e, the system 100 comprises the device 101 and the article 110. The heating element 220 in the chamber 211 comprises the seal 300. With each of these embodiments, the seal 300 may be a discrete element on the heating member 224. In embodiments, the seal 300 is a one-piece component with the heating member 224. The arrangement is generally the same as described above and so a detailed description will be omitted, with features of the above and below embodiments applicable to each other. In the embodiments described with reference to FIGS. 5, 6 and 7a-7e the configuration, such as shape and dimensions, of the seal member differs.

As shown in FIG. 5, the heating element 220 comprises a seal member 310. The seal member 310 comprises a peripheral protrusion 310. The protrusion 310 extends circumferentially around the seal member 310. The seal member 310 is spaced from the base of the receptacle 212. The seal member 310 is proximal to the distal end of the heating element 220. In embodiments the seal member 310 is at the juncture of the heating element 220 and receptacle 212. The protrusion 310 forms a collar. The protrusion comprises an outer surface having a proximal face 311 and a distal face 312. The proximal and distal faces 311, 312 converge to an outer edge 313. The outer edge 313 forms a ridge.

Upon insertion of the article 110 into the heating chamber 211, the insertion end 112 of the article 110 contacts the seal member 310. Upon a maintained insertion action, the article 110 deforms and/or distends to receive the seal member 310 therein. In embodiments of the article 110 comprising the preformed bore 113, the seal member 310 acts on the inner surface 114 of the bore 113 to seal thereagainst. In embodiments, the seal member 310 forms an indent in the inner surface 114.

In embodiments, the seal member 310 has differing configurations. As shown in FIG. 7a, a seal member 315 of the seal 300 has an arcuate profile. That is, at least part of an outer surface 316 of the seal member 315 is curved. Such a configuration may aid to minimise the required insertion and removal force whilst maintaining a good barrier action.

As shown in FIG. 7b, the seal 300 may comprise two or more seal members 320, 321. Each of the seal members 320, 321 extends around the periphery of the heating member 224. As shown, the seal members 320, 321 are adjacent to each other, and may be a one-piece component an/or integrally formed. In embodiments the seal members 320, 321 are axially spaced as shown in FIG. 7d. By providing a plurality of seal members 320, 321 it is possible to provide redundancy, for example if one seal member fails to engage with the article 110.

Further configurations are envisaged, for example the seal 300 is shown in FIG. 7c with a seal member having an axially extending face 326 between proximal and distal faces 326, 327. Such an arrangement aids maximise contact area between the seal member and the article 110.

In each of the above described embodiments, the seal member is configured to engage with a relatively more resilient engaging feature of the article. Upon insertion, the seal member is arranged to deform and/or distend a feature of the article to form a barrier. The seal member is relatively rigid.

In other embodiments, including those having the same or similar configuration to the embodiments described above the seal is arranged to engage with a relatively less resilient engaging feature of the article. Upon insertion, the seal member itself is arranged to deform and/or distend upon contact with a feature of the article to form a barrier. In such embodiments, the seal member shown in each of FIGS. 2, 3, 4, 5, 6 and 7a-7d comprises a flexible member.

In embodiments, the seal member is hollow to allow a flexible shell of the seal member to deform inwardly. In embodiments, the seal member distends downwardly. For example, the seal members in each of FIGS. 5 and 7a-7d in embodiments are o-rings. The seal member may be a deformable rubber seal element.

The seal member in embodiments is arranged to act as a lip seal.

As shown in FIG. 7e, the seal 300 comprises a seal member 330 acting as a flexible seal. The seal member 330 is a lip seal. The seal member 330 comprises a deformable collar around the heating member 224. The seal member 330 comprises a circumferential leg.

The seal member 330 acts as a skirt. The seal member 330 has a peripheral lip 331. The lip 331 acts as the contact edge for the seal member 330. The seal 330 may comprise two or more seal members axially aligned along the heating member 224. The seal member 330 is biased to deform upon contact with the inner surface 114 of the bore 113 of the article 110. By providing the bore 113 in the article 110 and the flexible lip seal it is possible to minimise the insertion and removal force required whilst ensuring a good sealing action. By providing the preformed bore it is possible to increase the resilience of the seal member 330 as the seal member is slid along the bore upon insertion of the heating member 224 into the article 110.

As shown, for example in FIG. 6, in embodiments the seal 300 comprises a step 335. The step 335 may be formed by a shoulder 336 of the heating element 220. The step 335 in embodiments is formed by a sleeve. The step 335 may be formed by a portion of the receptacle 212, for example a flange upstanding from the base.

In embodiments, the article 110 comprises a corresponding engaging feature configured to interact with the seal 300. The engaging feature may be at least one of a collar, a shoulder, a ridge, a protrusion, a recess, a lip, a chamfer, a skirt, a flared portion, a region of increased thickness, a region of reduced thickness, a face and an edge.

In FIG. 6, a recess 116 in the inner surface 114 of the bore 113 forms the engaging feature. The recess 116 extends from the insertion end 112. In embodiments, the recess 116 is spaced from the insertion end 112. The recess 116 in such embodiments forms a circumferentially extending channel. The recess 116 forms a recess shoulder 117. The recess shoulder acts as an engaging face locatable the step 335.

By providing the seal member on the heating element, it is possible to provide a sealing action between the heating element and the article within the article whilst simplifying the arrangement and manufacturing of the article. As the article is a consumable, whereas the device is reusable it is possible to simplify the system and reduce components of the system along the lifetime of the device.

Although the seal is described with the seal member on the heating element, it will be understood that the seal may be spaced from the heating element, and/or comprise one or more seal members spaced from the heating element.

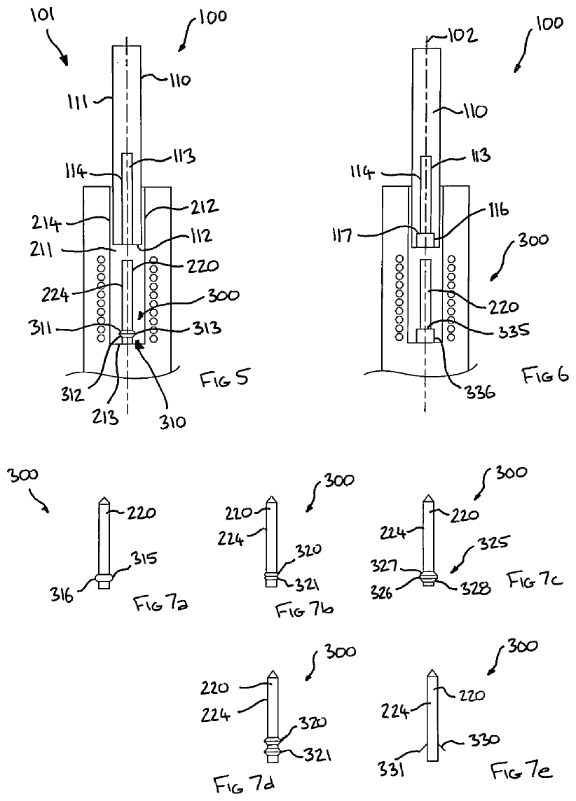

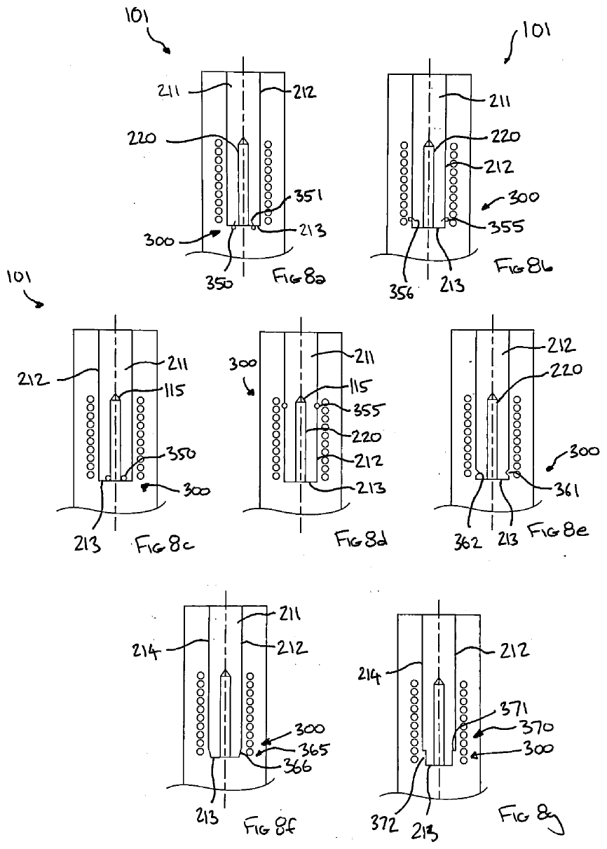

In embodiments described with reference to FIGS. 8a-8g, the system 100 comprises the device 101 and the article 110 (not shown in FIGS. 8a-8g). The receptacle 212 comprises the seal 300. With each of these embodiments, the seal 300 may be a discrete element on the receptacle 212. In embodiments, the seal 300 is a one-piece component with the receptacle 212, or be integrally formed with the receptacle 212. The arrangement is generally the same as described above and so a detailed description will be omitted, with features of the above and below embodiments applicable to each other. In the embodiments described with reference to FIGS. 8a-8g the configuration, such as shape and dimensions, of the seal member differs.

As shown in FIG. 8a, the receptacle 8a comprises the seal 300. A seal member 350 is on the end wall 213, acting as the base of the receptacle 212. The seal member 350 upstands from the base. The seal member 350 is a face seal. The seal member 350 extends circumferentially around the heating element 220. The seal member 350 is spaced from the heating element 220. The seal member 350 comprises a sealing lip 351. The sealing lip 351 extends circumferentially. The seal member 350 is resilient and deforms upon contact with the insertion end 112 of the article to form a seal therewith. The seal member 350 forms a circumferentially extending seal. In embodiments, the seal member 350 has a different configuration, such as an o-ring. In embodiments, the seal member is a gasket. The seal member 350 may be at the juncture of the heating element 220 and receptacle 212. In embodiments the seal member 350 is a discrete element located on the face of end wall 213, as shown in FIG. 8c.

In embodiments, the seal member 350 is rigid. That is the seal member is configured to act on and distend and/or deform the insertion end 112 of the article 110 to form a seal therewith. In such an arrangement, the seal member 350 defines a circumferentially extending ridge.

As shown in FIG. 8b, the seal 300 comprises a seal member 355 on the peripheral wall 214 of the receptacle 212. The seal member 355 protrudes from the peripheral wall 214. The seal member 355 is a lip seal. The seal member 355 encircles the heating element 220. The seal member 355 is spaced from the heating element 220. The seal member 355 is spaced from the end wall 213. The seal member 355 comprises a sealing lip 356. The sealing lip 356 extends circumferentially. The seal member 356 is configured to contact and seal with the outer side 111 of the article 110. The seal member 355 is resilient and deforms upon contact with the outer side 111 of the article to form a seal therewith. The seal member 355 forms a circumferentially extending seal.

In the embodiment shown in FIG. 8b, the seal member 355 is at the distal end of the heating chamber 211. In embodiments, the position of the seal member 355 may vary. For example, in an embodiment shown in FIG. 8d. The seal member 355 is proximal the free end 115 of the heating element 220. In embodiments, the seal member 355 has a different configuration, such as an o-ring as shown in FIG. 8b.

In embodiments, the seal member is rigid. That is the seal member is configured to act on and distend and/or deform the article 110 to form a seal therewith. One such arrangement is shown in FIG. 8e. A seal member 360 comprises a peripheral protrusion 361. The seal member 360 of the seal 300 defines a circumferentially extending ridge. The protrusion 361 protrudes radially inwardly. An outer edge 362 forms a ridge.

In the embodiment shown in FIG. 8e, the seal member 360 is spaced from the base of the receptacle 212. In embodiments, for example referring to FIGS. 8f and 8g, a seal member 365 is at the juncture of the peripheral wall 214 and end wall 213. The seal member 365 may have different configurations. As shown in FIG. 8f, the seal member 365 comprises a chamfer 366. The chamfer 366 defines a tapered portion of the heating chamber 211. The tapered portion is at the distal end. As shown in FIG. 8g, a seal member 370 of the seal 300 comprises a step 371. The step 371 is formed by a shoulder 372 of the receptacle 212. The step 371 in embodiments is formed by an insert in the receptacle 212.

FIG. 2A shows another embodiment. The embodiment of FIG. 2A corresponds generally to that of FIG. 2, except that the heating element 220 protrudes from the housing 103. In such an embodiment, the device is free from a receptacle in which the heating element is received. That is, the heating zone 215 is free from being surrounded or delimited by any other component.

The housing 103 defines the base 213a from which the heating element 220 protrudes. The heating element 220 upstands from the base 213a. The heating element 220 is configured to receive at least a portion of the article 110. The heating element 220 is exposed. The term ‘exposed’ will be understood to mean that a portion of a feature is not surrounded by another feature such that the feature extends beyond an external extent. The heating element 220 is not received in a heating chamber. With the device of FIG. 2A, the heating element extends beyond an external extent of the housing of the device. In the embodiment of FIG. 2A, the entire heating element 220 protruding from the base is free from being surrounded. In embodiments, a substantial portion of the heating element 220 is exposed. The heating element 220 is substantially free from being surrounded or delimited by another component. In such an embodiment, a minor portion of the heating element extends within the external extent of the housing of the device. Optionally, at least 80% of the heating element 220 is exposed, optionally 60%, and optionally 50%.

The heating arrangement in embodiments is an inductive heating arrangement. The inductive coil may extend in the heating element 220. The heating arrangement in embodiments is a resistive heating arrangement.

FIG. 2A also shows an article 110 for use with any of the embodiments described herein. The article 110 of FIG. 2A is generally the same as the article 110 of FIG. 2. The article 110 of FIG. 2A may be used with the aerosol generating device 101 of FIG. 2A. The article 110 comprises the bore 113. The bore 113 may be omitted.

FIG. 2A also shows a seal 300. The seal 300 is generally the same as the seal 300 of FIG. 2. The seal 300 is configured to seal with the article 110. The seal 300 seals with the article 110 at the base end 221 of the heating element 220. The seal 300 seals the heating element 220 with the insertion end 112 of the article. That is, a sealing action is formed between the article 110 and the heating element 220. The seal 300 encircles the heating member 224. The seal 300 comprises a chamfer 301. The chamfer 301 acts as a seal member 305. The chamfer 301 forms a tapered end of the heating element 220. The chamfer 301 comprises a contact surface 302. The contact surface 302 extends at an inclined angle to the longitudinal axis.

In embodiments, the heating element 220 is exposed, with a portion of the heating element encircled by an upstanding rim 230 upstanding on the base 213a. The heating element 220 partially protrudes from the housing 103. That is, a portion of the heating element 220 protrudes from the housing 103 and a portion of the heating element 220 is surrounded by other components of the device. For example, the housing 103 may comprise the upstanding rim 230 extending around and spaced from the heating element 220. The upstanding rim 230 may extend around and be spaced from a base end 221 of the heating element 220. The upstanding rim 230 extends from the base 213a. The upstanding rim 230 extends circumferentially. The upstanding rim 230 may comprise a peripheral portion. The upstanding rim 230 of the base 213a forms a recess 212a. The recess 212a houses the base end 221 of the heating element 220. The recess 212a may be configured to receive an end of the article 110. A major portion of the heating element 220 is free from being surrounded or delimited by any other component. The heating zone 215 is free from being surrounded or delimited by any other component

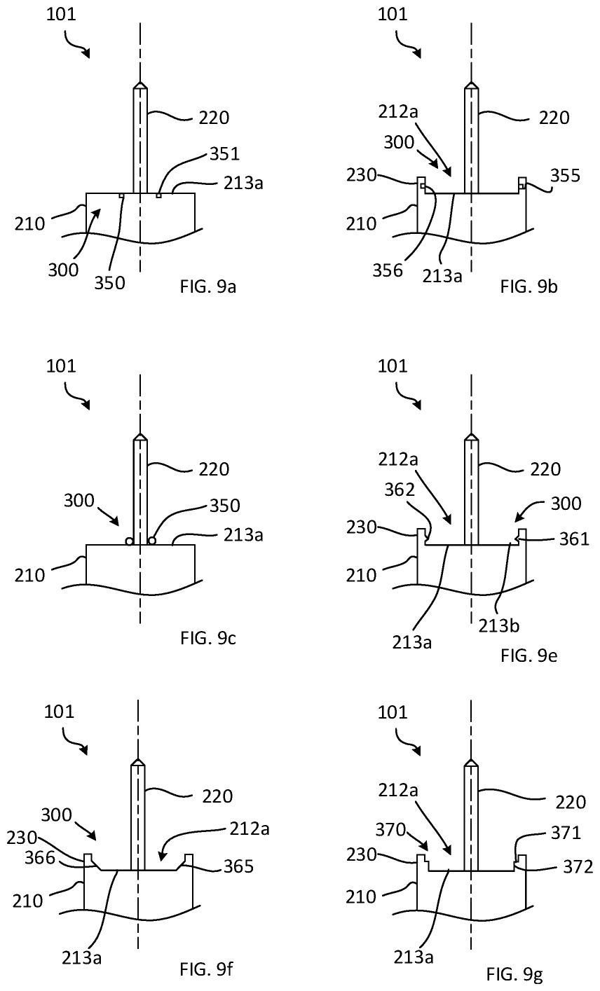

Some embodiments are described with reference to FIGS. 9a, 9b, 9c, 9e, 9f and 9g. The system 100 comprises the device 101 and the article 110 (not shown in these Figures). The base of the housing comprises the seal 300. With each of these embodiments, the seal 300 may be a discrete element on the base. In embodiments, the seal 300 is a one-piece component with the base, or be integrally formed with the base. The arrangement is generally the same as described above and so a detailed description will be omitted, with features of the above and below embodiments applicable to each other. In the embodiments described with reference to FIGS. 9a, 9b, 9c, 9e, 9f and 9g the configuration, such as shape and dimensions, of the seal member differs.

As shown in FIG. 9a, a seal member 350 is on the base. The seal member 350 upstands from the base. The seal member 350 is a face seal. The seal member 350 extends circumferentially around the heating element 220. The seal member 350 is spaced from the heating element 220. The seal member 350 comprises a sealing lip 351. The sealing lip 351 extends circumferentially. The seal member 350 is resilient and deforms upon contact with the insertion end 112 (not shown) of the article to form a seal therewith. The seal member 350 forms a circumferentially extending seal. In embodiments, the seal member 350 has a different configuration, such as an o-ring. In embodiments, the seal member is a gasket. The seal member 350 may be at the juncture of the heating element 220 and the base 213a. In embodiments the seal member 350 is a discrete element located on the face of the base, as shown in FIG. 9c.

As shown in FIG. 9b, the seal 300 comprises a seal member 355 on the upstanding rim 230. The seal member 355 protrudes from the upstanding rim. The seal member 355 is a lip seal. The seal member 355 encircles the heating element 220. The seal member 355 is spaced from the heating element 220. The seal member 355 is spaced from the base. The seal member 355 comprises a sealing lip 356. The sealing lip 356 extends circumferentially. The seal member 356 is configured to contact and seal with the outer side 111 of the article 110. The seal member 355 is resilient and deforms upon contact with the outer side 111 of the article to form a seal therewith. The seal member 355 forms a circumferentially extending seal.

In embodiments, the seal member is rigid. That is the seal member is configured to act on and distend and/or deform the article 110 to form a seal therewith. One such arrangement is shown in FIG. 9e. A seal member 360 comprises a peripheral protrusion 361. The seal member 360 of the seal 300 defines a circumferentially extending ridge. The protrusion 361 protrudes radially inwardly. An outer edge 362 forms a ridge.

In the embodiment shown in FIG. 9e, the seal member 360 is spaced from a base surface 213b of the base. In embodiments, for example referring to FIGS. 9f and 9g, a seal member 365 is at the juncture of the upstanding rim 230 and the base surface 213b. The seal member 365 may have different configurations. As shown in FIG. 9f, the seal member 365 comprises a chamfer 366. The chamfer 366 defines a tapered portion of the recess. As shown in FIG. 9g, a seal member 370 of the seal 300 comprises a step 371. The step 371 is formed by a shoulder 372 of the upstanding rim 230. The step 371 in embodiments is formed by an insert in the recess.

It will be understood that the exposed heating arrangement may be provided in combination with any of the embodiments described above.

In embodiments, the article 110 comprises a corresponding outer engaging feature configured to interact with the seal 300. The outer engaging feature may be at least one of a collar, a shoulder, a ridge, a protrusion, a recess, a lip, a chamfer, a skirt, a flared portion, a region of increased thickness, a region of reduced thickness, a face and an edge.

Generally spacing the seal 300, or at least a seal member of the seal from the heating element it is possible to define an air path between the seal 300 and the heating element 220. For example an air conduit may be defined in the base radially inwardly for the seal 300. By providing the seal 300 radially outwardly of the conduit, it is possible to isolate a radially inward portion of the chamber 211 from a radially outward portion of the chamber 211 when the article is received therein. Similarly, by providing the seal axially spaced from the base, it is possible to isolate a proximal portion of the chamber 211 from a distal portion of the chamber 211 when the article is received therein.

In embodiments the seal acts as a retention feature to aid retention of the article in the device. The seal can act to provide user feedback to indicate when the article is correctly located in the device. In embodiments the system acts to improve reliability of the system by restricting the insertion of articles that do not form part of the system into the device, either fully or partially.

In the above described embodiments, the heating arrangement is an inductive heating arrangement. In embodiments, other types of heating arrangement are used, such as resistive heating. The configuration of the device is generally as described above and so a detailed description will be omitted. In such arrangements the heating assembly 201 comprises a resistive heating generator including components to heat the heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating assembly comprises electrical contacts for supplying electrical current to the resistive material.

In embodiments, the heating element forms the resistive heating component itself. In embodiments the resistive heating component transfers heat to the heating element, for example by conduction.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol generating device for generating an aerosol from aerosol-generating material comprising:
a receptacle defining a heating zone configured to receive at least a portion of an article comprising aerosol-generating material,
a heating element protruding into the heating zone; and
a seal arranged to seal between the article and at least one of the receptacle and the heating element.

2. The device of claim 1, wherein the seal protrudes in the heating zone.

3. The device of claim 1, comprising an opening at a proximal end of the receptacle through which at least a portion of an article is received and a distal end; wherein the seal is at the distal end.

4. The device of claim 1, wherein the seal extends around the heating element.

5. The device of claim 1, wherein the seal comprises at least one of a lip seal, an o-ring, a face seal, a chamfer, a collar, a shoulder, a gasket and a protrusion.

6. (canceled)

7. The device of claim 1, wherein the seal is configured to seal with the article at a juncture of the heating element and the receptacle.

8. The device of claim 1, wherein the heating element comprises at least a part of the seal.

9. The device of claim 8, wherein the heating element comprises a heating member and a seal member of the seal around the heating member.

10. (canceled)

11. (canceled)

12. The device of claim 1, wherein the receptacle comprises at least a part of the seal.

13. The aerosol generating device of claim 12, wherein the receptacle comprises a base and a peripheral wall and wherein at least one of the based and the peripheral wall comprises a seal member of the seal.

14. (canceled)

15. (canceled)

16. (canceled)

17. (canceled)

18. (canceled)

19. The device of claim 1, wherein the seal is configured to at least one of deform and distend at least a portion of an article when the article is received in the heating zone or wherein the seal is configured to at least one of distend and deform when at least a portion of an article is received in the heating zone.

20. (canceled)

21. (canceled)

22. (canceled)

23. (canceled)

24. An aerosol-generating system comprising
an article comprising aerosol-generating material; and
an aerosol generating device for heating aerosol-generating material comprising:
a receptacle defining a heating zone configured to receive at least a portion of the article;
a heating element that protrudes into the heating zone; and
a seal on at least one of the receptacle and the heating element configured to define at least part of an air path extending through the article which is isolated from at least part of a gap formed between the receptacle and the article.

25. The aerosol provision system of claim 24, wherein the article comprises a pre-formed bore configured to receive the heating element.

26. The aerosol provision system of claim 25, wherein the seal is configured to seal with a face of the bore.

27. The aerosol provision system of claim 24, wherein the article comprises an engaging feature configured to engage with the seal and, optionally,
wherein the engaging feature is at least one of a bore, a collar, a shoulder, a ridge, a protrusion, a recess, a lip, a chamfer, a region of increased thickness, a region of reduced thickness, a face and an edge.

28. The aerosol provision system of claim 24, wherein the seal is configured to engage with a relatively more resilient engaging feature of the article.

29. (canceled)

30. (canceled)

31. An aerosol generating device for generating an aerosol from aerosol-generating material comprising:
a heating element configured to be received within at least a portion of an article comprising aerosol-generating material;
a base from which the heating element protrudes; and
a seal arranged to seal between the article and at least one of the base and the heating element.

32. The device of claim 31, comprising a heating zone around the heating element configured to at least partially receive the article comprising aerosol-generating material.

33. (canceled)

34. (canceled)

35. The device of claim 31, wherein at least part of the heating element is exposed.

36. The device of claim 31, wherein the seal is at a base end of the heating element.

37. (canceled)

38. (canceled)

39. (canceled)
